(19) United States
(12) Patent Application Publication
(10) Pub. No.: US 2003/0118073 A1
(43) Pub. Date: Jun. 26, 2003

(54) Compact optical amplifier, a system incorporating the same, and an optical amplification method

(75) Inventor: David A. Rockwell, Culver City, CA (US)

Correspondence Address: FULBRIGHT AND JAWORSKI L L P, PATENT DOCKETING 29TH FLOOR, 865 SOUTH FIGUEROA STREET, LOS ANGELES, CA, 900172576

(73) Assignee: fSona Communications Corporation

(21) Appl. No.: 10/027,766

(22) Filed: Dec. 21, 2001

(51) Int. Cl. H01S 3/091

(52) U.S. Cl. 372/70

(57) ABSTRACT

An optical amplifier comprising a pump source and a light-transmitting medium. The light-transmitting medium is power-coupled to the pump source and has a first side and a convex side. The first side opposes and lies at least partially within a focal plane of the convex side. An optical coating that reflects optical signals is disposed on the first side. The light-transmitting medium amplifies optical signals through stimulated emission.

### BACKGROUND OF THE INVENTION

1. Field of the Invention

The field of the present invention is optical amplifiers.

2. Background

Optical amplifiers are used to amplify light in various applications, with probably the most common application being the amplification of optical telecommunications signals. Several types of optical amplifiers exist, including fiber amplifiers, semiconductor optical amplifiers, and waveguide amplifiers. Fiber amplifiers are presently the most widely used in telecommunications because they offer a combination of high efficiency, high gains and output powers, and low noise figures.

The typical fiber amplifier consists of a coiled optical fiber and a pump laser. The core of the fiber is typically silica glass, although other materials may be used, doped with rare-earth ions such as erbium, ytterbium, etc., which provide optical amplification through a process known as stimulated emission. The pump laser provides the energy for the stimulated emission process. The wavelength of light that is amplified is largely dependent upon the type of dopant. For example, in telecommunications, the dopant typically consists of erbium ions because erbium provides relatively efficient stimulated emission in the 1550 nm wavelength range, the common wavelength used for telecommunications. Other dopants are used to achieve amplification at other wavelengths.

In order to achieve the gain needed for most telecommunications applications, the doped optical fiber in a fiber amplifier needs to be relatively long (typically 5 to 20 meters). The length is determined by a number of parameters, including the cross-sectional size of the fiber core, dopant densities, and pump absorption. Such long doped fibers are frequently coiled to make the fiber amplifiers more compact and to facilitate handling, installation, repairs, etc. However, the smaller the coil radii of the doped optical fiber, the greater the loss in efficiency. Therefore, practical limits exist as to how compact a fiber amplifier may be constructed.

### SUMMARY OF THE INVENTION

The present invention is directed to a compact optical amplifier, a system including such an optical amplifier, and an optical amplification method. The compact optical amplifier comprises a light-transmitting medium and a pump source. The pump source is power-coupled to the light-transmitting medium to inject pump power into the light-transmitting medium. The light-transmitting medium includes integrated refractive and/or reflective optics and absorbs the pump power to provide amplification to an optical signal via stimulated emission.

Thus in a first separate aspect of the present invention, a compact optical amplifier comprises a light-transmitting medium and a pump source. The light-transmitting medium absorbs pump power from the pump source and provides amplification to an optical signal through stimulated emission. The light-transmitting medium has a first side and a convex side, with the first side opposite to and lying at least partially within the focal plane of the convex side. The pump source is power-coupled to the light-transmitting medium to inject the pump power into the light-transmitting medium. The optical amplifier further comprises an optical coating disposed on the first side of the light-transmitting medium to reflect the optical signal. The first side may be planar to simplify the optics of the optical amplifier.

In a second separate aspect of the present invention, the light-transmitting medium includes one or more dopants to amplify an optical signal through stimulated emission and a graded-index of refraction. The graded index of refraction may gradually vary along a direction orthogonal to an optical axis of the light-transmitting medium. A first side of the light-transmitting medium may include an optical coating that reflects optical signals.

In a third separate aspect of the present invention, the pump source is a laser that is optically coupled to the light-transmitting medium so that pump radiation is injected into the light-transmitting medium along an optical axis of the light-transmitting medium.

In a fourth separate aspect of the present invention, optical signals entering the light-transmitting medium through the convex or second side also exit the light-transmitting medium through the convex or second side.

In a fifth separate aspect of the present invention, the light-transmitting medium may be cylindrical or rod shaped, and may comprise a silica glass, phosphate glass, or any other appropriate optical material.

In a sixth separate embodiment of the present invention, the dopant may be any dopant known to provide stimulated emission to an optical signal after absorbing appropriate pump power. The dopants may include various ions of rare-earth elements, either individually or in combination.

In a seventh separate aspect of the present invention, a compact optical amplifier may be incorporated into an optical telecommunications system, wherein the optical signals originate from an input aperture and are imaged onto an output aperture by the refractive properties of the optical amplifier.

In an eighth separate aspect of the present invention, any of the foregoing aspects may be employed in combination.

Accordingly, it is an object of the present invention to provide a compact optical amplifier, a system incorporating the compact optical amplifier, and an optical amplification method. Other objects and advantages will appear hereinafter.

### BRIEF DESCRIPTION OF THE DRAWINGS

In the drawings, wherein like reference numerals refer to similar components:

FIG. 1 illustrates a compact optical amplifier in accordance with an embodiment of the present invention;

FIG. 2 the compact optical amplifier of FIG. 1 incorporated into a telecommunications system;

FIG. 3 illustrates the positions of the input and output optical signals relative to the light-transmitting medium in the system of FIG. 2;

FIG. 4 illustrates a compact optical amplifier in accordance with another embodiment of the present invention;

FIG. 5 illustrates the distribution of the graded index of refraction for the compact optical amplifier of FIG. 4;

FIG. 6 illustrates the compact optical amplifier of FIG. 4 incorporated into a telecommunications system;

FIG. 7 illustrates a compact optical amplifier in accordance with another embodiment of the present invention incorporated into a telecommunications system; and

FIG. 8 illustrates a compact optical amplifier in accordance with another embodiment of the present invention incorporated into a telecommunications system.

### DETAILED DESCRIPTION OF THE PREFERRED EMBODIMENTS

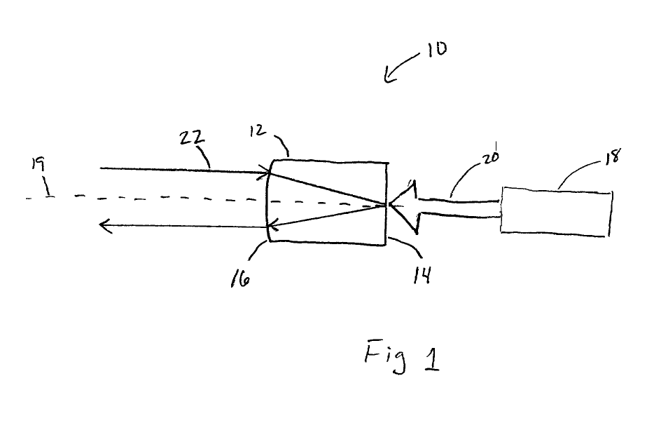

Turning in detail to the drawings, FIG. 1 illustrates a first embodiment of a compact optical amplifier 10 for amplifying optical signals. The optical amplifier 10 comprises a light-transmitting medium 12 and a pump laser 18. The pump laser 18 is optically coupled to a first or planar side 14 of the light-transmitting medium 12 to inject pump radiation 20 into the light-transmitting medium 12 through the planar side 14. An optical coating is placed on the planar side 14 to transmit light at the pump radiation wavelength and reflect light at the optical signal wavelength. The operational wavelength of the pump laser 18 is chosen such that the pump radiation 20 is absorbed by one or more dopants in the light-transmitting medium 12. After absorbing the energy from the pump radiation 20, the dopants provide amplification to optical signals through stimulated emission, a process that is well known to those skilled in the art and therefore only briefly discussed herein.

The planar side 14 of the light-transmitting medium 12 is opposite to and lies wholly within the focal plane of the convex side 16. An optical signal 22 following a path parallel to the optical axis 19 of the light-transmitting medium 12 is refracted by the convex side 16 as it enters the light-transmitting medium and directed towards the planar side 14. The optical signal 22 is reflected by the optical coating at the planar side 14 and directed back towards the convex side 16. At the convex side 16, the optical signal 22 exits the light-transmitting medium 12 and is refracted by the convex side 16 so that its path is once again parallel to the optical axis 19. In addition, optical signals entering the light-transmitting medium having a divergence from the optical axis 19 that is less than or equal to a maximum angle will emerge from the light-transmitting medium having approximately the same angle of convergence toward the optical axis. The maximum angle is a function of the radius of curvature of the convex side, the transverse dimensions of the light-transmitting medium, and the refractive index of the light-transmitting medium. The planar side 14 of the light-transmitting medium 12 may instead have a non-planar geometry. If a non-planar geometry is used, the angles of an optical signal entering and exiting the light-transmitting medium, relative to the optical axis, should be as described above.

The integrated optical elements of the light-transmitting medium of FIG. 1 enable the light-transmitting medium to image an optical signal from an input aperture onto an output aperture. In the absence of imaging, an optical signal propagating from an input aperture through the light-transmitting medium and coupled into an output aperture naturally loses power. The amount of power lost largely depends upon the spatial size of the optical signal at the input aperture, the distance between the input aperture and the output aperture, and the size of the output aperture. By way of example, for an optical signal having a wavelength of 1550 nm that is propagating through free space between two Corning SMF-28 optical fibers, manufactured by Corning, Inc. of New York, approximately 50% of the signal power is lost over propagation distances of approximately 100 μm, and approximately 90% of the signal power is lost over propagation distances of approximately 300 μm. Most applications require the optical signal power to be maintained above a certain threshold level. In such applications, avoiding excessive power loss is often critical for maintaining the usefulness of the optical signal. An example of such an application may be found in telecommunications, where excessive power loss may result in a loss of the information carried by the optical signal.

The light-transmitting medium thus preserves information carried by the optical signal by using integrated optical elements to create an image of the optical signal. The optical elements may be as described herein in connection with the various embodiments, or they may be appropriately modified for particular needs. In modifying the optical properties of the light-transmitting medium, those skilled in the art will recognize that many different configurations are possible. Other configurations may include additional integrated refractive and/or reflective optics to achieve single-pass or multi-pass imaging of the optical signal.

The light-transmitting medium 12 shown in FIG. 1 is cylindrical or rod shaped. However, with the exception of the above noted constraints between the convex side 16 and the planar side 14, the light-transmitting medium 12 may have any geometric shape. The preferred base material for the light-transmitting medium 12 is phosphate glass. Other types of glass, including silica glass, and other appropriate optical materials, such as yttrium-aluminum-garnet (YAG), sapphire, ruby, and some semiconductor materials, may also be used for the light-transmitting medium 12. The base material should be a material that is transparent to the wavelength of the optical signal and can provide stimulated emission at the optical signal wavelength.

The dopants included in the light-transmitting medium 12 are chosen based on the ability to provide stimulated emission at the optical signal wavelength being amplified. The light-transmitting medium 12 may be doped with almost any element, molecule, or combination thereof that exhibits lasing properties, such as rare-earth elements or transition metals. Some rare-earth elements that are known to provide stimulated emission include erbium, ytterbium, thulium, neodymium, samarium, and various combinations of these elements. For telecommunications applications, the dopants often comprise erbium or a combination of erbium and ytterbium. These dopants provide stimulated emission at 1550 nm, a standard wavelength used in optical telecommunications. Other applications may use optical signals having different wavelengths and therefore require different dopants.

Ytterbium may be used as a co-dopant with erbium in silica or phosphate glass to increase the efficiency and the gain of the optical amplifier. When erbium is used as the sole dopant in glass, a phenomena known as “pair interactions” occurs between neighboring erbium atoms. These pair interactions increase as the erbium density increases, monotonically decreasing the efficiency of the optical amplifier. Hence, these pair interactions establish a practical upper limit to the erbium concentration. Pair interactions may also be reduced through the base material selected for the light-transmitting medium. For example, erbium may have a higher density in phosphate glass, as compared to silica glass, before pair interactions occur. For this reason, phosphate glass is preferred for applications requiring high erbium concentrations, while either phosphate or silica glass may be used for other applications.

In an erbium-ytterbium doped optical amplifier, the erbium preferably has a density at which pair interactions are minimal or do not occur. The ytterbium dopant concentration may be maximized such that the physical properties of the light-transmitting medium are not altered to the extent that light-transmitting medium becomes unusable for a desired application. In phosphate glass, for example, the ytterbium dopant concentration may be at least an order of magnitude greater than that of an erbium dopant without introducing undesired properties to the light-transmitting medium. The primary benefit of co-doping glass with ytterbium is gained because ytterbium absorbs pump radiation at many of the same wavelengths as erbium. In addition, once ytterbium absorbs the pump radiation, much of the absorbed energy is efficiently transferred to the erbium. Thus, the erbium dopant gains more energy for the stimulated emission process than would otherwise be possible with the erbium alone.

The pump laser 18 may inject the pump radiation 20 into the light-transmitting medium 12 using any number of methods known to those skilled in the art. The method of pumping will determine the size of the active amplification region within the light-transmitting medium. The light-transmitting medium 12 may be pumped longitudinally or transversely. Transverse pumping means that the pump radiation is directed radially towards the optical axis of the light-transmitting medium. Longitudinal pumping means that the pump radiation is directed along the optical axis of the light-transmitting medium.

In the optical amplifier of FIG. 1, the light-transmitting medium 12 is longitudinally pumped. Longitudinal pumping provides at least three advantages for this configuration over transverse pumping. First, because of the geometry of the light-transmitting medium in this embodiment, longitudinal pumping facilitates achieving a high degree of spatial overlap between the pump radiation and the optical signal, thereby ensuring efficient energy transfer from the pump beam to the signal beam. Second, this configuration also provides a greater length over which the pump light can be absorbed, therefore allowing greater flexibility in specifying the precise pump wavelength and, hence, the pump absorption coefficient. Third, longitudinal pumping creates less transverse variation in the optical gain profile, and hence less transverse distortion of the amplified optical signal than would a transverse pumping configuration.

The pump laser 18 may be optically coupled to the light-transmitting medium 12 through fiber pigtails. The fiber pigtails may be coupled to the light-transmitting medium directly or by any number of refractive or reflective optical interfaces known to those skilled in the art. Such optical interfaces include GRIN lenses from NSG America of Somerset, N.J., or power combiners from Resonance Photonics of Markham, Ontario, Canada. The shape of the bundle of fiber pigtails may also effect the efficiency of the fiber amplifier. Depending upon the circumstances, it may be desirous to shape the bundle of fiber pigtails in a close or loose packed circular bundle, in a linear array, or in some other configuration.

Alternative pump sources may be used in place of the pump laser to provide pump power to the light-transmitting medium. For example, it may be desirable to pump the light-transmitting medium with electromagnetic power, depending upon the ability of the light-transmitting medium to absorb the electromagnetic power and provide stimulated emission at a desired wavelength. Those skilled in the art will recognize that other types of pump sources may also be used.

In general, parasitic oscillations may arise in an amplifying light-transmitting medium because stray reflections off opposing parallel surfaces within the light-transmitting medium create radiative feedback. Parasitic oscillations are undesirable in practical optical amplifiers, because they degrade performance and can also reduce the reliability of the optical components. In the light-transmitting medium 12, parasitic oscillations in the longitudinal direction are not likely to occur because the non-planar nature of the convex side almost totally eliminates the possibility of light making many round trips through the light-transmitting medium. Those parasitic oscillations that do occur in the longitudinal direction may be inhibited by placing the planar side at a slight angle to the normal of the optical axis. The amount of the slight angle depends upon the physical dimensions of the light-transmitting medium, but it should be such that any oscillating light will exit the light-transmitting medium after just a few reflections.

Transverse oscillations in the light-transmitting medium are naturally inhibited by the erbium dopant outside of the active amplification region. This occurs because erbium is a strong absorber of 1550 nm radiation when it is not being pumped. Transverse oscillations may be additionally reduced by making the longitudinal surfaces of the light-transmitting medium non-parallel. Having non-parallel longitudinal surfaces will cause any oscillating radiation to exit the light-transmitting medium after just a few reflections.

In an erbium-ytterbium doped amplifier, the ytterbium may cause parasitic oscillations because the ytterbium dopant may lase at about 1060 nm. Transverse parasitic oscillations in the ytterbium population may be eliminated by surrounding the light-transmitting medium with samarium-doped glass. The samarium-doped glass helps eliminate stray radiation in the 1060 nm range because it is a highly absorbing medium at wavelengths near 1000 nm. Longitudinal parasitic oscillations in the ytterbium population may be eliminated by the same techniques previously mentioned.

Parasitic oscillations may also occur between any two opposing reflective surfaces where the light-transmitting medium is optically disposed between the two surfaces. These types of parasitic oscillations may be eliminated by inserting filters and/or optical isolators on one or more sides of the light-transmitting medium.

Due to the heat generated by the pump radiation in the light-transmitting medium, the temperature of the light-transmitting medium will increase during operation. Under some circumstances, it may be desirable to minimize this temperature increase by cooling or sinking the non-critical outer surfaces of the light-transmitting medium. However, by cooling some of the outer surfaces of the light-transmitting medium, a temperature gradient and thermally induced strains may be established within the light-transmitting medium. Such a temperature gradient and the accompanying strains will cause thermal lensing, due to the dependence of the refractive index on temperature and the local strains, and result in refraction of the optical signal within the light-transmitting medium. While such thermal lensing may alter the optical path of the optical signal, adjustments to the curvature of the convex side, the distance between the convex side and the planar side, or both may appropriately account for the change in the optical path. The goal of such adjustments is to maintain the planar side in the same position relative to the focal plane of the convex side.

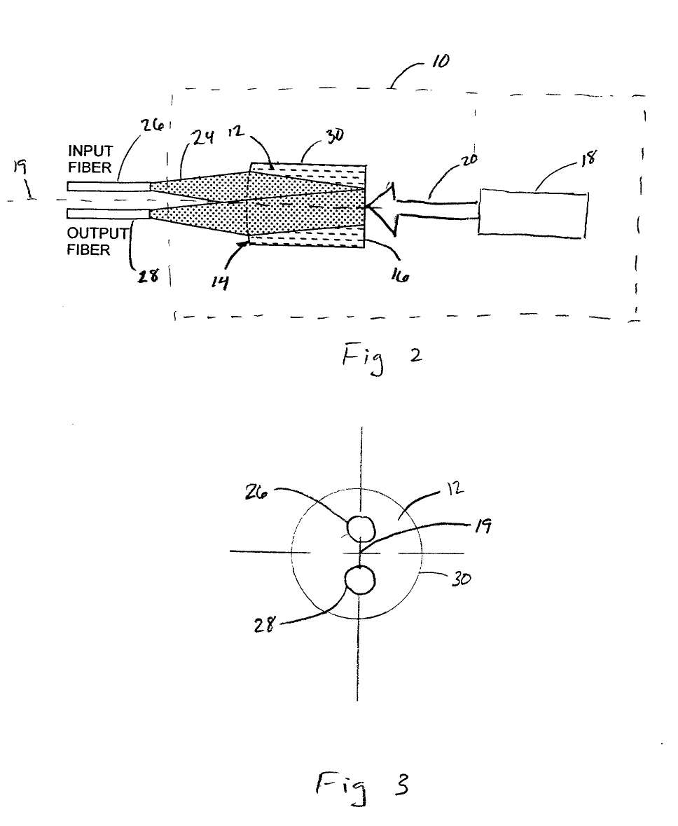

FIG. 2 illustrates a compact optical amplifier 10 incorporated into an optical telecommunications system. The optical amplifier 10 may be disposed at any position within the optical telecommunications system to amplify optical telecommunications signals. Input and output fibers are optically coupled to the convex side 14 of the light-transmitting medium 12. The optical signals 24 emerge from the input fiber 26 and are imaged onto an output fiber 28 by the refractive and reflective properties of the light-transmitting medium 12. Optical signals may also emerge from the output fiber 28 and be imaged onto the input fiber 26. The optical amplifier 10 may also be optically coupled to any optical signal carrying device employed in optical telecommunications.

The input and output fibers 26, 28 are disposed at approximately one focal length away from the convex side 14 of the light-transmitting medium 12. Disposed thusly, the optical signals 24 emerging from the input fiber 26 are imaged onto the output fiber 28 without the need of further refractive or reflective optical interfaces. The need of further optical interfaces is also avoided by having the input and output fibers 26, 28 disposed equidistant from the light-transmitting medium 12. Nevertheless, additional refractive or reflective optical interfaces may be disposed between the fibers and the light-transmitting medium if desired or needed for different configurations.

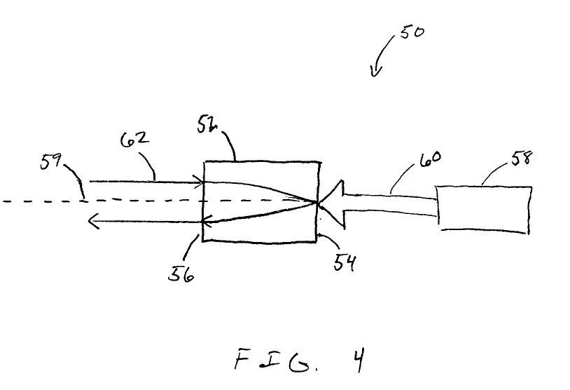

FIG. 3 illustrates the positions of the input and output fibers 26, 28 relative to the optical axis 19 of the light-transmitting medium 12 and each other. Each fiber 26, 28 is offset from the optical axis 19 an equal distance and in a direction that is directly opposite the other fiber. Each fiber 26, 28 is also disposed such that the longitudinal axis of the fiber end that faces the light-transmitting medium 12 is oriented parallel to the optical axis 19. The light-transmitting medium 12 has a diameter such that, when the fibers are positioned as described, the diverging optical signal emerging from the input fiber 26 is wholly incident upon the convex side 14 without the need for intervening optical interfaces. Thus, the diverging optical signal has an angle relative to the optical axis 19 that is less than the maximum angle. These optical signals are imaged onto the output fiber 28 without the need for intervening optics.

Each of the position parameters discussed in relation to FIGS. 2 and 3 may be modified as desired. However, in modifying one parameter, other parameters may also need modification to account for the change or intervening optical interfaces may be necessary to ensure the optical signal emerging from the input fiber is appropriately imaged onto the output fiber.

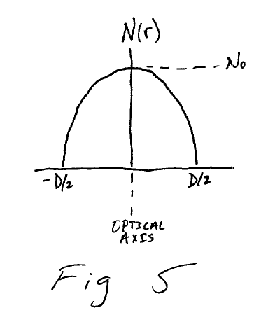

A first alternative embodiment of a compact optical amplifier 50 is illustrated in FIG. 4. In this embodiment, the first and second opposing ends 54, 56 of the light-transmitting medium 52 are planar. The first side 54 includes an optical coating that transmits the pump radiation wavelength and reflects the optical signal wavelength. The pump laser 58 is optically coupled to the first side 54 to inject pump radiation 60 into the light-transmitting medium 52, which includes at least one dopant that provides amplification to optical signals through stimulated emission. The same considerations are relevant to the choice of dopants, shape, base material, and method of pumping for the light-transmitting medium 52 as were discussed in connection with FIG. 1.

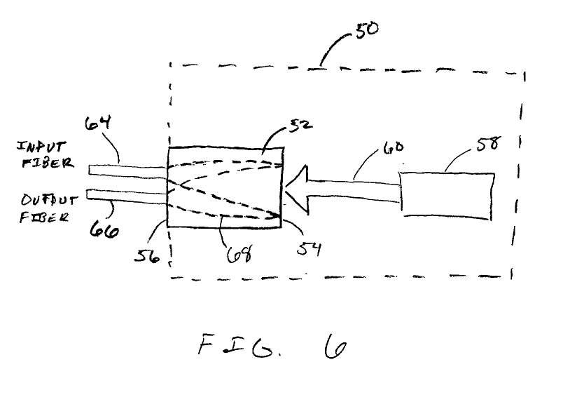

The light-transmitting medium 52 has a graded index of refraction that varies in a direction orthogonal to the optical axis 59 of the light-transmitting medium 52. FIG. 5 illustrates graphically the radial distribution of the index of refraction, n(r). At the optical axis of the light-transmitting medium, the index of refraction is at a maximum n₀. Between the optical axis and the periphery of the light-transmitting medium, represented by D/2 and −D/2 in FIG. 5, the index of refraction is a quadratic function of the radial distance from the optical axis. Because the graded index of refraction varies in this manner, a light beam initially displaced relative to the optical axis follows a sinusoidal path relative to the optical axis when traveling through the light-transmitting medium. Additionally, whether the optical signal remains within the light-transmitting medium depends upon the distance of the optical signal path from the optical axis and the angle of the optical signal relative to the optical axis as the optical signal enters the light-transmitting medium. The gradient of the index of refraction may have other distributions, however, changing the distribution is likely to change the functional optics of the light-transmitting medium as described herein. Thus, other distributions may require additional optical elements.

The distance between the first and second sides 54, 56 of the light-transmitting medium 52 is such that light may travel approximately one-quarter of a full sine wave while traversing the light-transmitting medium 52 from the second side 56 to the first side 54, or vice-versa. Those skilled in the art will recognize that the refractive properties of the light-transmitting medium 52 are the same as some quarter pitch GRIN lenses, such as those sold by the aforementioned NSG America. However, the optical coating on the first side 54 effectively gives the light-transmitting medium 52 a half pitch length for the optical signals. Thus, an optical signal 62 following a path parallel to the optical axis 59 and entering the light-transmitting medium 52 through the second side 56 exits the light-transmitting medium 52 through the second side 56. The relative positions of the entering and exiting optical signal are equidistant from the optical axis 59, however, the point at which the optical signal exits is directly opposite the optical axis 59 from where the optical signal 62 entered the light-transmitting medium 52.

The geometries of the optical amplifier 52 may give rise to parasitic oscillations or thermal lensing. For longitudinal oscillations, the first and second sides may be slightly tilted relative to each other. The slight tilt, as previously discussed, causes oscillating radiation to exit the light-transmitting medium after just a few reflections. The same techniques previously discussed may also be utilized to reduce or eliminate parasitic oscillations. Heat generated by the pump radiation may cause thermal lensing. Such thermal lensing may be determined in advance and, if necessary, the length of the light-transmitting medium 52 between the first and second sides 54, 56 may be adjusted accordingly to correct for the thermal lensing.

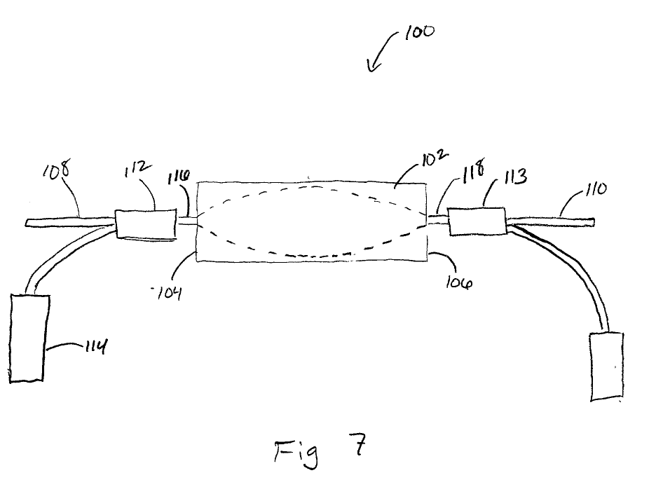

FIG. 6 illustrates the optical amplifier 50 of FIG. 4 incorporated into a telecommunications system. The input and output fibers 64, 66 are optically coupled directly to the second side 56 of the light-transmitting medium 52. The fibers 64, 66 may be also be optically coupled to the light-transmitting medium 52 with a variety of intervening optics. The optical signals 68 entering the light-transmitting medium 52 at a location displaced from the optical axis follow a sinusoidal path relative to the optical axis when propagating through the light-transmitting medium. After propagating along a path length corresponding to one quarter of a sine wave, the optical signals are reflected at the first side 54 and directed back towards the second side 56. As the optical signals reach the second side 56, they are imaged onto the output fiber 66 by the cumulative effect of the graded index of the light-transmitting medium 52 and the reflection at the first side 54. Thus, the optical amplifier 50 may be optically coupled to optical fibers or other optical signal carrying devices within an optical telecommunications system to provide gain to optical telecommunications signals.

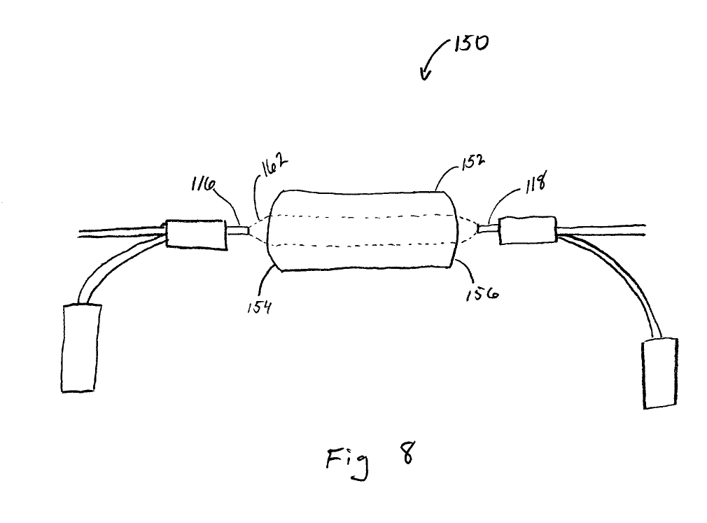

Another alternative embodiment of a compact optical amplifier 100, shown incorporated into a telecommunications system, is illustrated in FIG. 7. In this embodiment, the light-transmitting medium 102 is composed of materials appropriate to amplify the optical signal wavelength. The light-transmitting medium 102 also has a graded index of refraction, as previously discussed, so that the transverse position of the light passing through follows a sinusoidal variation. The distance between the first and second sides 104, 106 of the light-transmitting medium 102 is such that light may travel approximately one-half of a full sine wave while traversing the light-transmitting medium 102 from the first side 104 to the second side 106, or vice-versa. Those skilled in the art will recognize that the refractive properties of the light-transmitting medium 102 are the same as some half pitch GRIN lenses, such as those sold by the aforementioned NSG America.

The input fiber 108 is optically coupled to the first side 104 of the light-transmitting medium 102 and the output fiber 110 is optically coupled to the second side 106 of the light-transmitting medium 102 via multiplexors 112, 113. Optical signals from the input fiber 108 and pump radiation from a first pump laser 114 enter the multiplexor and are combined onto an input coupling fiber 116 that is optically coupled to the light-transmitting medium 102. The optical signals are imaged onto an output coupling fiber 118 at the second side 106 by the graded index of the light-transmitting medium 102. The output coupling fiber 118 is optically coupled to the second multiplexor 113, from which the optical signals are directed into the output fiber 110. Pump radiation is injected into the light-transmitting medium 102 through second side 106 by way of the second multiplexor 113.

Alternatively, pump radiation from a single pump laser may be divided and multiplexed with both the input and output fibers to inject pump radiation simultaneously into both ends of the light-transmitting medium. A second alternative is to inject pump radiation into the light-transmitting medium on only one of the sides. The optical signal and pump radiation may also be coupled to the light-transmitting medium through additional refractive or reflective optical interfaces.

FIG. 8 illustrates a telecommunications system 150 similar to that shown in FIG. 7, but with an alternative light-transmitting medium 152. The light-transmitting medium 152 has two opposing convex sides 154, 156 and is composed of materials appropriate to amplify the optical signal wavelength. The curvature of each convex side 154, 156 and the distance of the coupling fibers 116, 118 are such that diverging optical signals 162 emerging from the input coupling fiber 116 are appropriately imaged onto the output coupling fiber 118. The appropriate curvature and distance between the opposing convex sides may be easily determined based upon the known divergence of the optical signals from the coupling fibers.

Thus, a compact optical amplifier, a system incorporating the same, and an optical amplification method are disclosed. While embodiments of this invention have been shown and described, it would be apparent to those skilled in the art that many more modifications are possible without departing from the inventive concepts herein. The invention, therefore, is not to be restricted except in the spirit of the following claims.

What is claimed is:

1. An optical amplifier comprising:
a pump source that emits pump power;
a light-transmitting medium power-coupled to the pump source to receive the pump power and having a first side and a convex side, the first side being opposed to and lying at least partially within a focal plane of the convex side, wherein the light-transmitting medium amplifies an optical signal through stimulated emission; and
an optical coating disposed on the first side, wherein the optical coating reflects the optical signal.

2. The optical amplifier of claim 1, wherein the light-transmitting medium includes at least one dopant that absorbs the pump power.

3. The optical amplifier of claim 2, wherein the at least one dopant comprises erbium.

4. The optical amplifier of claim 2, wherein the at least one dopant comprises ytterbium.

5. The optical amplifier of claim 2, wherein the light-transmitting medium further comprises a glass rod.

6. The optical amplifier of claim 5, wherein the glass rod comprises silica glass.

7. The optical amplifier of claim 5, wherein the glass rod comprises phosphate glass.

8. The optical amplifier of claim 1, wherein the pump source is power-coupled to the first side and the optical coating transmits the pump power.

9. The optical amplifier of claim 1, wherein the pump source comprises a laser.

10. The optical amplifier of claim 1, wherein the first side is planar.

11. An optical amplifier comprising:
a pump laser that emits pump radiation;
a glass rod optically coupled to the pump laser to receive the pump radiation and having a planar side and a convex side, the planar side being opposed to and lying at least partially within a focal plane of the convex side, wherein the glass rod includes at least one dopant that amplifies an optical signal through stimulated emission; and
an optical coating disposed on the planar side, wherein the optical coating reflects the optical signal.

12. The optical amplifier of claim 11, wherein the glass rod comprises silica glass.

13. The optical amplifier of claim 11, wherein the glass rod comprises phosphate glass.

14. The optical amplifier of claim 11, wherein the pump laser is optically coupled to the planar side and the optical coating transmits the pump radiation.

15. The optical amplifier of claim 11, wherein the at least one dopant comprises erbium.

16. The optical amplifier of claim 11, wherein the at least one dopant comprises ytterbium.

17. An optical amplifier comprising:
a pump source that emits pump power; and
a light-transmitting medium power-coupled to the pump source to receive the pump power and having a graded index of refraction, wherein the light-transmitting medium amplifies an optical signal through stimulated emission.

18. The optical amplifier of claim 17, wherein the light-transmitting medium comprises at least one dopant that absorbs the pump power.

19. The optical amplifier of claim 18, wherein the at least one dopant comprises erbium.

20. The optical amplifier of claim 18, wherein the at least one dopant comprises ytterbium.

21. The optical amplifier of claim 18, wherein the light-transmitting medium further comprises a glass rod.

22. The optical amplifier of claim 21, wherein the glass rod comprises silica glass.

23. The optical amplifier of claim 21, wherein the glass rod comprises phosphate glass.

24. The optical amplifier of claim 17, wherein the graded index of refraction gradually varies along a direction orthogonal to an optical axis of the light-transmitting medium.

25. The optical amplifier of claim 17 further comprising an optical coating disposed on a first side of the light-transmitting medium, the optical coating being reflective to the optical signal.

26. The optical amplifier of claim 25, wherein the pump source is power-coupled to the first side and the optical coating transmits the pump power.

27. The optical amplifier of claim 17, wherein the pump source is power-coupled to a first side of the light-transmitting medium and to a second side of the light-transmitting medium, the second side being opposed to the first side.

28. The optical amplifier of claim 17, wherein the pump source comprises a laser.

29. An optical amplifier comprising:
a pump laser that emits pump radiation; and
a glass rod optically coupled to the pump laser to receive the pump radiation and having a graded index of refraction that gradually varies along a direction orthogonal to an optical axis of the glass rod, wherein the glass rod includes at least one dopant that amplifies an optical signal through stimulated emission.

30. The optical amplifier of claim 29, wherein the glass rod comprises silica glass.

31. The optical amplifier of claim 29, wherein the glass rod comprises phosphate glass.

32. The optical amplifier of claim 29 further comprising an optical coating disposed on a first side of the glass rod, the optical coating being reflective to the optical signal.

33. The optical amplifier of claim 29, wherein the pump laser is optically coupled to a first side of the glass rod.

34. The optical amplifier of claim 33, wherein the pump laser is additionally optically coupled to a second side of the glass rod, the second side being opposed to the first side.

35. The optical amplifier of claim 29, wherein the at least one dopant comprises erbium.

36. The optical amplifier of claim 29, wherein the at least one dopant comprises ytterbium.

37. An optical telecommunications system comprising:
an input fiber carrying one or more optical signals;
an output fiber;
a pump source that emits pump power; and
a light-transmitting medium being power-coupled to the pump source to receive the pump power and having a first side and a convex side, the first side being opposed to and lying at least partially within a focal plane of the convex side and including an optical coating that reflects the optical signals, wherein the input and output fibers are optically coupled to the convex side such that the light-transmitting medium images the optical signals from the input fiber onto the output fiber, and wherein the light-transmitting medium amplifies the optical signals through stimulated emission.

38. The system of claim 37, wherein the light-transmitting medium comprises at least one dopant that absorbs the pump power.

39. The system of claim 38, wherein the at least one dopant comprises erbium.

40. The system of claim 38, wherein the at least one dopant comprises ytterbium.

41. The system of claim 38, wherein the light-transmitting medium further comprises a glass rod.

42. The system of claim 41, wherein the glass rod comprises silica glass.

43. The system of claim 41, wherein the glass rod comprises phosphate glass.

44. The system of claim 37, wherein the pump source is power-coupled to the first side and the optical coating transmits the pump power.

45. The system of claim 37, wherein the pump source comprises a laser.

46. The system of claim 37, wherein the first side is planar.

47. An optical telecommunications system comprising:
an input fiber carrying one or more optical signals;
an output fiber;
a pump source that emits pump power; and
a light-transmitting medium being power-coupled to the pump source to receive the pump power and having a first convex side and a second convex side, the first convex side being opposed to the second convex side, wherein the input fiber is optically coupled to the first convex side and the output fiber is optically coupled to the second convex side such that the light-transmitting medium images the optical signals from the input fiber onto the output fiber, and wherein the light-transmitting medium amplifies the optical signals through stimulated emission.

48. The system of claim 47, wherein the light-transmitting medium comprises at least one dopant that absorbs the pump power.

49. The system of claim 48, wherein the at least one dopant comprises erbium.

50. The system of claim 48, wherein the at least one dopant comprises ytterbium.

51. The system of claim 48, wherein the light-transmitting medium further comprises a glass rod.

52. The system of claim 51, wherein the glass rod comprises silica glass.

53. The system of claim 51, wherein the glass rod comprises phosphate glass.

54. The system of claim 47, wherein the pump source comprises a laser.

55. The system of claim 47, wherein the pump source is power-coupled to the first convex side.

56. The system of claim 55, wherein the pump source is additionally power-coupled to the second convex side.

57. An optical telecommunications system comprising:
an input fiber carrying one or more optical signals;
an output fiber;
a pump source that emits pump power; and
a light-transmitting medium being power-coupled to the pump source to receive pump power and having a graded index of refraction, wherein the input and output fibers are optically coupled to the light-transmitting medium such that the light-transmitting medium images the optical signals from the input fiber onto the output fiber, and wherein the light-transmitting medium amplifies the optical signals through stimulated emission.

58. The system of claim 57, wherein the light-transmitting medium comprises at least one dopant that absorbs the pump power.

59. The system of claim 58, wherein the at least one dopant comprises erbium.

60. The system of claim 58, wherein the at least one dopant comprises ytterbium.

61. The system of claim 58, wherein the light-transmitting medium further comprises a glass rod.

62. The system of claim 61, wherein the glass rod comprises silica glass.

63. The system of claim 61, wherein the glass rod comprises phosphate glass.

64. The system of claim 57, wherein the graded index of refraction gradually varies along a direction orthogonal to an optical axis of the light-transmitting medium.

65. The system of claim 57, wherein the light-transmitting medium has a first side and a second side, the first side being opposed to the second side and including an optical coating that reflects the optical signals, and wherein the input and output fibers are optically coupled to the second side.

66. The system of claim 57, wherein the input fiber is optically coupled to a first side of the light-transmitting medium and the output fiber is optically coupled to a second side of the light-transmitting medium, the second side being opposed to the first side.

67. The system of claim 57, wherein the pump source is power-coupled to a first side of the light-transmitting medium.

68. The system of claim 67, wherein the pump source is additionally power-coupled to a second side of the light-transmitting medium, the second side being opposed to the first side.

69. The system of claim 57, wherein the pump source comprises a laser.

70. A method of amplifying an optical signal comprising:
directing the optical signal from an input aperture into a light-transmitting medium;
imaging the optical signal onto an output aperture with the light-transmitting medium; and
injecting pump power into the light-transmitting medium while the optical signal is passing through the light-transmitting medium, wherein the light-transmitting medium amplifies the optical signal through stimulated emission.

71. The method of claim 70, wherein imaging the optical signal onto the output aperture with the light-transmitting medium includes refracting the optical signal at a convex side of the light-transmitting medium.

72. The method of claim 70, wherein imaging the optical signal onto the output aperture with the light-transmitting medium includes refracting the optical signal within the light-transmitting medium.

73. The method of claim 70, wherein imaging the optical signal onto the output aperture with the light-transmitting medium includes internally reflecting the optical signal within the light-transmitting medium.

74. The method of claim 70, wherein injecting the pump power into the light-transmitting medium includes injecting the pump power into the light-transmitting medium along an optical axis of the light-transmitting medium.

75. A method of amplifying an optical signal comprising:
directing the optical signal into a light-transmitting medium having a graded index of refraction; and
injecting pump power into the light-transmitting medium while the optical signal is passing through the light-transmitting medium, wherein the light-transmitting medium amplifies the optical signal through stimulated emission.

76. The method of claim 75 further comprising internally reflecting the optical signal within the light-transmitting medium.

77. The method of claim 75, wherein injecting the pump power into the light-transmitting medium includes injecting the pump power through a first side of the light-transmitting medium along an optical axis of the light-transmitting medium.

78. The method of claim 77, wherein injecting the pump power into the light-transmitting medium further includes injecting the pump power through a second side of the light-transmitting medium, the second side being opposed to the first side.
